(19) United States
(12) Patent Application Publication
(10) Pub. No.: US 2025/0290823 A1
(43) Pub. Date: Sep. 18, 2025

(54) LEAKAGE DIAGNOSIS METHOD AND LEAKAGE DIAGNOSIS SYSTEM FOR A TANK OF A VEHICLE

(71) Applicant: Thomas Magnete GmbH, Herdorf (DE)

(72) Inventors: Olaf OHLIGSCHLÄGER, Grünebach (DE); Edwin KREUZBERG, Daaden (DE); Thomas FABIG, Nauroth (DE)

(21) Appl. No.: 18/860,329

(22) PCT Filed: Apr. 24, 2023
(86) PCT No.: PCT/EP2023/060560

§ 371 Date: Oct. 25, 2024

(30) Foreign Application Priority Data
Apr. 28, 2022 (DE) 10 2022 110 335.8

(51) Int. Cl. G01M 3/32; B60K 15/03; F04B 43/02; F04B 49/22; F04B 51/00

(52) U.S. Cl. CPC G01M 3/3209; F04B 43/02; F04B 49/22; F04B 51/00; B60K 15/03; B60K 2015/0321

(57) ABSTRACT

The system relates to a leakage diagnosis system and method for a tank of a vehicle, comprising at least one first connection point and a second connection point, which are each designed to be connected to the tank or to be open to an environment, at least one diaphragm pump which is designed for conveying fluid from the first connection point to the second connection point, at least one ventilation valve which is connected parallel to the diaphragm pump between the first connection point and the second connection point and which is designed to be switched into a first position in which the first connection point and the second connection point are fluidically connected, and into a second position which prevents a fluid flow at least from the second connection point to the first connection point, and at least one evaluation unit which is designed to operate the diaphragm pump, to switch the ventilation valve into the second position and to determine a pressure (curve) in the connected tank, in order to deduce the existence of a leakage in the tank from the pressure (curve). The evaluation unit is designed to detect electrical signals of the diaphragm pump, to detect a pressure generated by the diaphragm pump using at least one pressure sensor, and to determine the existence of a malfunctioning of the diaphragm pump using the electrical signals and the detected pressure.

### CROSS-REFERENCE TO RELATED APPLICATIONS

This application is a National Stage of International Application No. PCT/EP2023/060560, filed Apr. 24, 2023, which claims the benefit of and priority to German Patent Application DE 102022110335.8, filed Apr. 28, 2022. The entire disclosures of the above applications are incorporated by reference herein.

### FIELD

The invention relates to a leakage diagnosis system for a tank of a vehicle and a method for a functional diagnosis of the leakage diagnosis system, a method for heating the leakage diagnosis system and a method for operating the leakage diagnosis system. The invention also relates to a vehicle which has a tank and the leakage diagnosis system.

### BACKGROUND

This section provides background information related to the present disclosure which is not necessarily prior art.

Current leakage diagnostics systems for leakage diagnosis are used, among other things, in fuel tanks of motor vehicles. First, a pressure difference between the tank pressure and the ambient pressure is built up and a leakage in the tank is inferred from the tank pressure over time. A vane pump is used to build up a pressure difference between the tank pressure and the ambient pressure. The vane pump is operated until a predetermined pressure is reached in the tank. Due to the design-related leakage of the vane pump, the fluid flows out of the tank through the vane pump when the vane pump is at a standstill. In order to prevent such an outflow, which would falsify a leakage diagnosis of the tank, the vane pump continues to operate even during the leakage diagnosis. This results in pressure pulsations in the tank, which can make leakage detection in the tank more difficult. In addition, the vane pump used in the prior art is susceptible to dirt and wear due to the gap between the vane cells and the fixed housing. As the vane pump ages, its delivery rate decreases, which increases the time required to build up pressure in the connected tank. In addition, vane pumps are limited in their delivery capacity and cannot be used to build up pressure in large tanks. A reference orifice used in known leakage diagnosis systems also tends to become dirty and clogged. These known leakage diagnosis systems also have the disadvantage that—in the event of a malfunction of the vane pump—excessive overpressure can be created in the vehicle tank by the vane pump, resulting in damage to the tank or the vehicle. Known leakage diagnosis systems are also not able to carry out a self-diagnosis in which the function of the vane pump can be checked. Furthermore, these known systems are prone to errors, especially at low external temperatures, and often provide imprecise or external temperature-dependent results.

### SUMMARY

This section provides a general summary of the disclosure, and is not a comprehensive disclosure of its full scope or all of its features.

It is the object to provide a leakage diagnosis system for a tank of a vehicle which is less susceptible to contamination and wear, which can also bring larger tanks to a desired pressure in less time, which has increased safety and which is able to carry out a self-diagnosis, as well as a method for functional diagnosis of the leakage diagnosis system. Furthermore, it is an object to provide a leakage diagnosis system which is temperature-independent, in particular external temperature-independent.

This object is achieved by a leakage diagnosis system that has at least one first connection point and a second connection point, a diaphragm pump, a ventilation valve and at least one evaluation unit. The first connection point and the second connection point are each designed to be connected to a tank, for example a fuel tank, of a vehicle or to be open to the environment. In this way, a tank can be connected to one of the two connection points and the other connection point, to which the tank is not connected, can be open to the environment. The diaphragm pump is connected between the first connection point and the second connection point and is designed to convey a fluid from the first connection point to the second connection point. Thus, the diaphragm pump is designed to create a negative pressure in a tank connected to the first connection point by conveying fluid from the first connection point to the second connection point, or to generate an overpressure in a tank connected to the second connection point. Due to its design principle, a diaphragm pump has fewer wearing parts than a vane pump and is also less susceptible to contamination, resulting in slower aging. In addition, diaphragm pumps have higher flow rates, which make it possible to bring larger tanks to a desired pressure in a shorter time than is possible using a vane pump. The ventilation valve is connected parallel to the diaphragm pump between the first connection point and the second connection point and has at least one first position and at least one second position. In the first position of the ventilation valve, the first connection point and the second connection point are fluidically connected to each other so that fluids can flow in both directions between the first connection point and the second connection point through the ventilation valve. In the second position of the ventilation valve, at least one fluid flow from the second connection point to the first connection point is prevented by the ventilation valve. In particular, the ventilation valve in the second position completely prevents a flow of fluid between the first connection point and the second connection point. The ventilation valve is designed so that it can be switched between the first position and the second position, so that a switch can be made between a free flow of fluid between the first connection point and the second connection point in both directions via the ventilation valve and the fluid flow can be prevented at least from the second connection point to the first connection point by the ventilation valve. The leakage diagnosis system can be used to vent the tank. As a result the venting can be ensured at all times and, in particular, is only interrupted during leakage diagnosis. The evaluation unit is designed to operate the diaphragm pump and thus enable a fluid flow from the first connection point to the second connection point by means of the diaphragm pump. The evaluation unit is also designed to switch the ventilation valve from its first position to its second position and thus prevent the fluid flow at least from the second connection point through the ventilation valve to the first connection point. This means that fluid can only flow through the ventilation valve from the first connection point to the second connection point. The evaluation unit is also designed to determine a pressure, in particular a pressure curve, of a tank connected to the first connection point or the second connection point and from the determined pressure, in particular from the determined pressure curve, to draw conclusions about the presence of a leakage in the connected tank. By supplying fluid through the operation of the diaphragm pump, the tank can be brought to a desired pressure. The pressure difference between the pressure in the tank and the pressure in the environment results in a fluid flow between the tank and the diaphragm pump if there is a leakage. The resulting change in pressure in the tank over time can be used to draw conclusions about the presence of a leakage in the tank. This temporal pressure curve in the tank can, for example, be compared with previously experimentally determined, stored temporal pressure curves of the tank at different magnitudes of leakage of the tank in order to draw conclusions about the magnitude of the leakage in the tank. The evaluation unit is also set up to detect electrical signals, in particular a current consumption of the diaphragm pump, to detect a pressure generated by the diaphragm pump by at least one pressure sensor and to determine the presence of a malfunction of the diaphragm pump by the electrical signals and the detected pressure. By determining the presence of a malfunction of the diaphragm pump by the evaluation unit, the leakage diagnosis system can carry out a self-diagnosis, in particular without the need for additional elements or components.

The pressure detected by the at least one pressure sensor, which is an actual pressure, is compared with a target pressure generated by the diaphragm pump. A difference is formed between the actual pressure and the target pressure. In particular, if a threshold value for this difference is exceeded, a malfunction of the diaphragm pump is detected or determined. At least one of the pressure sensor(s) used for this purpose can be part of the leakage diagnosis system, in particular installed in a module of the leakage diagnosis system. Alternatively or additionally, at least one of the pressure sensor(s) used for this purpose can be installed or used in the tank of the vehicle.

In an embodiment, the leakage diagnosis system comprises at least one first pump valve and at least one second pump valve. Here, the first pump valve is connected in series between the first connection point and the diaphragm pump and the second pump valve is connected in series between the diaphragm pump and the second connection point with the diaphragm pump. The first pump valve is designed so that during an intake process of the diaphragm pump a fluidic connection between the first connection point and the diaphragm pump is established and there is no fluidic connection from the diaphragm pump to the first connection point during a compression process of the diaphragm pump. The second pump valve is designed so that during an intake process of the diaphragm pump there is no fluidic connection between the second connection point and the diaphragm pump and during a compression of the diaphragm pump there is a fluidic connection between the diaphragm pump and the second connection point. As a result, the leakage diagnosis system is designed so that fluids flow from the first connection point and not from the second connection point into the diaphragm pump during an intake process of the diaphragm pump and through a compression process flow from the diaphragm pump to the second connection point and not to the first connection point. In this way, the leakage diagnosis system is designed to increase a negative pressure in the connected tank at a tank connected to the first connection point with each intake process of the diaphragm pump and, in a tank connected to the second connection side, to increase an overpressure in the connected tank with each compression process of the diaphragm pump. This embodiment also prevents a fluidic connection between the second connection point and the first connection point through the diaphragm pump.

In a further embodiment of the leakage diagnosis system, the first pump valve and the second pump valve are non-return valves, in particular umbrella valves. The first non-return valve and the second non-return valve are aligned in the same direction and allow a fluid flow from the first connection point to the diaphragm pump and from the diaphragm pump to the second connection point, so that there is no free fluid flow between the second connection point and the first connection point via the diaphragm pump. The leakage diagnosis system is thus set up to convey fluids in only one direction through the diaphragm pump, from the first connection point to the second connection point. The leakage diagnosis system is set up to prevent a free flow of fluid from the second connection point to the first connection point through the diaphragm pump. The first pump valve and the second pump valve are each connected to both sides of a diaphragm of the diaphragm pump in order to enable continuous fluid delivery through the diaphragm pump.

In a further embodiment of the leakage diagnosis system, the ventilation valve is held in its first position by an elastic restoring force of a spring and can be moved to its second position by an electromagnet. In this case, the ventilation valve is designed so that the electromagnet can act against the elastic restoring force of the spring when energized and can transfer the ventilation valve from the first position to the second position and hold it in the second position. Without energization, the electromagnet cannot act against the restoring force of the spring, so that the spring transfers the ventilation valve from the first position to the second position. The electromagnet can be designed in such a way that it can be controlled by the evaluation unit. In particular, the electromagnet can be designed in such a way that it can be energized during operation of the diaphragm pump and the duration of the leakage diagnosis and the ventilation valve closes so that no pressure equalization can take place via the ventilation valve between the second connection point and the first connection point for the duration of the leakage diagnosis. If no leakage diagnosis takes place, the ventilation valve is held open by the restoring force of the spring. As no actuation or energization is required for this first position of the ventilation valve, venting of the tank is ensured at all times.

In another embodiment, the leakage diagnosis system comprises an electric motor, an eccentric and a connecting rod. Here, the eccentric is connected to the electric motor and one end of the connecting rod is connected to the eccentric. The diaphragm of the diaphragm pump is connected to the other end of the connecting rod, which is not connected to the eccentric. These elements of the leakage diagnosis system are designed in such a way that the operation of the electric motor causes a lifting movement of the diaphragm of the diaphragm pump. This lifting movement of the diaphragm of the diaphragm pump causes an intake process or a compression process and thus an overpressure or a negative pressure in a tank connected to the first connection point or second connection point.

The leakage diagnosis system has at least one pressure sensor that is fluidically connected to the first connection point or the second connection point. This means that the pressure sensor is designed to measure the pressure of a tank connected to the first connection point or the second connection point. The pressure sensor is connected to the evaluation unit. This allows the pressure, in particular the pressure curve, to be measured in the tank by the evaluation unit. In particular, the at least one pressure sensor is fluidically connected between the diaphragm pump and the first connection point or the second connection point to the first connection point or the second connection point. This allows the leakage diagnosis system to be designed as compactly as possible.

The leakage diagnosis system has at least one first pressure sensor and a second pressure sensor. The first pressure sensor is fluidically connected to the first connection point and the second pressure sensor is fluidically connected to the second connection point in order to detect the pressure of a tank connected to the first connection point or second connection point and a pressure in the environment. This makes it easy to determine an overpressure or negative pressure in the tank compared to the environment by the evaluation unit. This also makes it possible to determine both the presence of a leakage in the tank and the size of a leakage by the evaluation unit. For this purpose, for example, after setting a desired pressure in the tank, the further pressure curve over time in the tank can be recorded by the pressure sensor and compared by the evaluation unit with stored pressure curves over time, taking into account the ambient pressure. This provides a particularly efficient and precise leakage diagnosis. Furthermore, the first pressure sensor and/or second pressure sensor can be used by the evaluation unit to detect a malfunction of the diaphragm pump by the evaluation unit.

If the leakage diagnosis system has a safety valve, the safety valve is designed to at least partially reduce a pressure difference between the first connection point and the second connection point. In the event of excessive overpressure at the second connection point, the safety valve can thus compensate for this overpressure to prevent damage to the components of the leakage diagnosis system.

The safety valve is connected to the second connection point at its first end, for example, and is open to the environment at its second end. This allows the safety valve to equalize excessive overpressure at the second connection point, in particular in the tank, directly with an ambient pressure (atmospheric pressure). Alternatively, the safety valve can be connected at its first end is connected to the first connection point and is open to the environment at its second end. This allows the safety valve, in the event that the first connection point is connected to the tank, to compensate for excessive negative pressure at the first connection point, in particular in the tank, directly with the ambient pressure.

The safety valve is connected to the first connection point and to the second connection point parallel to the diaphragm pump and/or parallel to the ventilation valve. As a result, if the pressure difference between the first connection point and the second connection point is too great, the safety valve can enable a fluidic connection between the first connection point and the second connection point in order to compensate for the aforementioned pressure difference.

The safety valve is designed to open at a first predetermined pressure difference as the opening pressure and to close at a second predetermined pressure difference as the closing pressure. The opening pressure and the closing pressure are different from each other.

If the closing pressure is lower than the opening pressure. In particular, this prevents the safety valve from constantly opening and closing.

In a further embodiment, the safety valve is in particular a spring-loaded non-return valve. This means that the safety valve can be manufactured cost-effectively and simply and that a compact size of the leakage diagnostics system can be provided.

The evaluation unit is set up to determine the pressure from electrical signals from the diaphragm pump. The pressure, in particular the pressure curve, is determined from a current value recorded or consumed by the pump and/or a consumed power at a known nominal voltage of the diaphragm pump, or time curves thereof. If the fluid delivery line of the diaphragm pump is known, the set pressure can be determined from the determined output of the diaphragm pump.

Alternatively, a table with experimentally determined current values, in particular current curves, at different pressures, in particular pressure curves, of a tank connected to the first connection point or second connection point can be stored. The pressure, in particular the pressure curve, of the fluid in a tank connected to the first or second connection point can be determined from the comparison of the current value determined by the evaluation unit, in particular a current curve, with such a stored table.

The system also relates to a method for a functional diagnosis of a leakage diagnosis system, wherein the leakage diagnosis system has at least one first connection point and a second connection point, a diaphragm pump and a ventilation valve. The first connection point and the second connection point are designed to be connected to a tank or to be open to the environment. The diaphragm pump is arranged between the first connection point and the second connection point, is fluidically connected to both connection points and is designed to convey fluid between the first connection point and the second connection point. The ventilation valve is connected parallel to the diaphragm pump between the first connection point and the second connection point and is designed to be switched between a first position and a second position. In the first position, the ventilation valve enables a fluidic connection between the first connection point and the second connection point. This allows fluid to flow in both directions through the ventilation valve. In the second position, the ventilation valve prevents fluid flow between the first connection point and the second connection point. The functional diagnosis method has the following steps. A first diagnosis step in which the ventilation valve is switched to the second position. A second diagnosis step in which the diaphragm pump is operated. In particular, the diaphragm pump is operated in pulsating mode. The operation of the diaphragm pump generates an overpressure or a negative pressure, in particular pulsating, in a tank connected to the first connection point or to the second connection point. A third diagnosis step in which the pressure generated by the diaphragm pump is detected by at least one pressure sensor. A fourth diagnosis step in which the presence of a malfunction of the diaphragm pump is detected by at least one electrical signal generated to operate the diaphragm pump and by the detected pressure. This allows the leakage diagnosis system to carry out a self-diagnosis.

The method has a fifth diagnosis step in which an electrical signal of the ventilation valve generated by the switching of the ventilation valve is detected, and a sixth diagnosis step in which the generated electrical signal of the ventilation valve is used to determine the presence of a malfunction of the ventilation valve. This also allows a self-diagnosis to be carried out to determine a malfunction of the ventilation valve of the leakage diagnosis system.

The system also relates to a method for heating, in particular for defrosting, a leakage diagnosis system, wherein the leakage diagnosis system comprises at least one first connection point and a second connection point, a diaphragm pump and a ventilation valve. The first connection point and the second connection point are designed to be connected to a tank or to be open to the environment. The diaphragm pump is arranged between the first connection point and the second connection point, is fluidically connected to both connection points and is used to convey fluid between the first connection point and the second connection point. The ventilation valve is connected parallel to the diaphragm pump between the first connection point and the second connection point and is designed to be switched between a first position and a second position. In the first position, the ventilation valve enables a fluidic connection between the first connection point and the second connection point. This allows fluid to flow in both directions through the ventilation valve. In the second position, the ventilation valve prevents fluid flow between the second connection point and the first connection point. The heating method has the following step. A heating step in which electrical signals, in particular a high-frequency current, are supplied to the diaphragm pump and/or the ventilation valve. The electrical signals are designed in such a way that the diaphragm pump does not perform a stroke, in particular a complete stroke, and/or that the ventilation valve is not switched, in particular not completely, between the first position and the second position, so that the diaphragm pump and/or the ventilation valve is/are heated by the electrical signals. This allows the leakage diagnosis system to be set to a predetermined operating temperature, in particular before leakage diagnosis. This ensures in particular that the result of the leakage diagnosis is not dependent on the external temperature.

The leakage diagnosis system can also be used to carry out a leakage diagnosis method for a tank, in particular a fuel tank, of a vehicle. In this case, the leakage diagnosis system comprises at least one first connection point and a second connection point, a diaphragm pump and a ventilation valve. The first connection point and the second connection point are designed to be connected to a tank or to be open to the environment. The diaphragm pump is arranged between the first connection point and the second connection point, is fluidically connected to both connection points and is designed to convey fluid between the first connection point and the second connection point. The ventilation valve is connected parallel to the diaphragm pump between the first connection point and the second connection point and is designed to be switched between a first position and a second position. In the first position, the ventilation valve enables a fluidic connection between the first connection point and the second connection point. This allows fluid to flow in both directions through the ventilation valve. In the second position, the ventilation valve prevents fluid flow between the second connection point and the first connection point. The method for leakage diagnosis is carried out as follows. In a first method step, the ventilation valve is switched to the second position. This causes a fluid flow through the ventilation valve from the second connection point to the first connection point. In a second method step, the diaphragm pump is operated to generate an overpressure or a negative pressure in a tank connected to the first connection point or second connection point. In a third method step, a pressure, in particular a pressure curve, is determined in the connected tank in order to draw conclusions about the presence of a leakage in the tank.

The invention also relates to a vehicle comprising a tank and the leakage diagnosis system according to the previous preferred embodiments, wherein the tank is fluidically connected to the first connection point or the second connection point of the leakage diagnosis system.

In particular, the vehicle can be a motor vehicle.

In particular, the evaluation unit can have or can be a processor, such as a CPU/GPU/FPGA. In particular, the evaluation unit can be an engine control unit of the vehicle. Alternatively or additionally, the evaluation unit can have a transceiver by means of which commands for operation and/or determined results of the evaluation unit can be transmitted wirelessly.

The system additionally relates to a method for operating a leakage diagnosis system. The leakage diagnosis system can be used in accordance with one of the above embodiments. The method for operating the leakage diagnosis system has the above method steps. For example, the method for leakage diagnosis, the method for functional diagnosis and/or the method for heating the leakage diagnosis system can be combined with each other as desired. For example, the method for heating can be carried out first, followed by the method for leakage diagnosis and then the functional diagnosis method. In particular, this allows a result of the leakage diagnosis method to be checked by the functional diagnosis method. Alternatively, for example, the functional diagnosis method can be carried out before the leakage diagnosis method to ensure that the subsequent result of the leakage diagnosis is reliable and accurate. If a malfunction of the leakage diagnosis system is detected during the functional diagnosis method, the method for heating said system can be carried out, for example, and the functional diagnosis repeated in order to rule out a temperature-dependent malfunction.

The leakage diagnosis system of all the above embodiments is set up to selectively carry out the aforementioned methods of all the above preferred embodiments, in particular by means of the evaluation unit.

Further areas of applicability will become apparent from the description provided herein. The description and specific examples in this summary are intended for purposes of illustration only and are not intended to limit the scope of the present disclosure.

### DRAWINGS

Further details, advantages and features of the present invention are shown in the following description of exemplary embodiments based on the drawing, in which:

FIG. 1 shows a sketch of a vehicle with a leakage diagnosis system according to an embodiment of the present invention;

FIG. 2 shows a sketch of the leakage diagnosis system according to the embodiment of the present invention;

FIG. 3 shows a sketch illustrating an exemplary structure of a diaphragm pump of the leakage diagnosis system according to the embodiment of the present invention; and

FIG. 4 shows a block diagram of a method for operating the leakage diagnosis system according to an embodiment of the present invention.

Corresponding reference numerals indicate corresponding parts throughout the several views of the drawings.

### DETAILED DESCRIPTION

Example embodiments will now be described more fully with reference to the accompanying drawings.

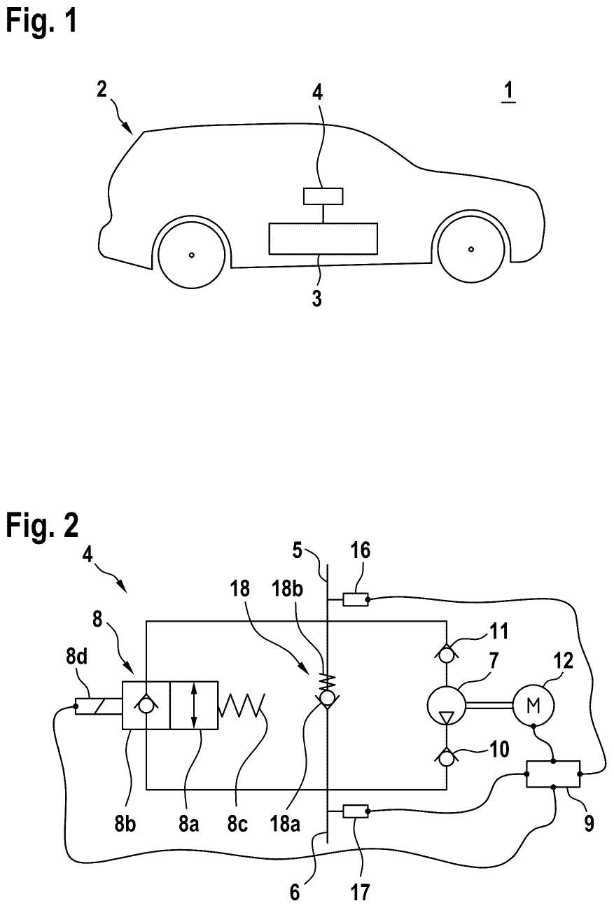

FIG. 1 shows a sketch of a vehicle 2 with a tank 3 for fuel and a leakage diagnosis system 4 according to an embodiment. The reference sign 1 indicates an environment 1, wherein the environment 1 is air (atmosphere).

The leakage diagnosis system 4 can be permanently installed in the vehicle 2. Alternatively, the leakage diagnosis system 4 can be removed from the vehicle 2 in a non-destructive manner, wherein one or more connections to the tank 3 can also be detached in a non-destructive manner.

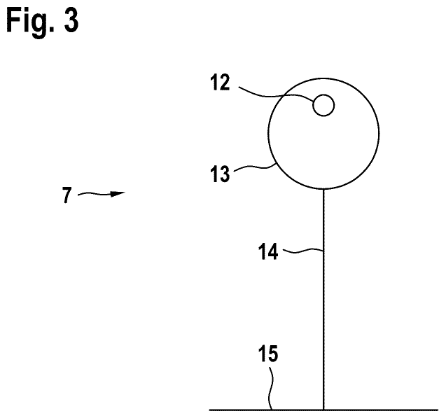

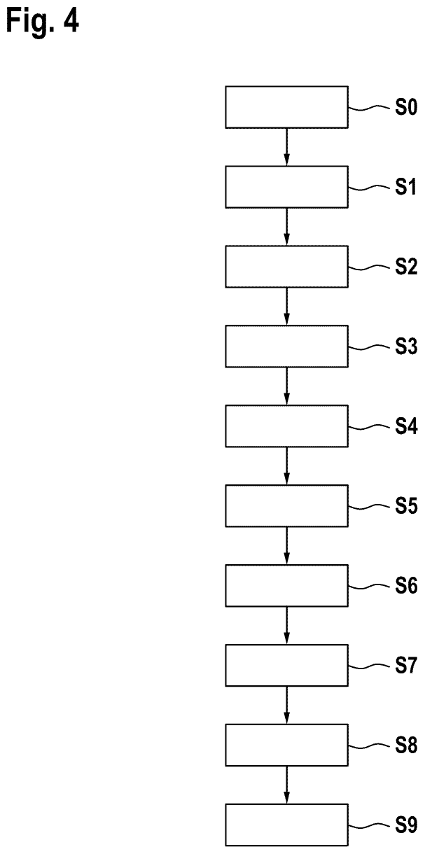

First, an exemplary structure and the functioning of the leakage diagnosis system 4 are explained with reference to FIGS. 2 and 3. The method for leakage diagnosis is explained with reference to FIG. 4.

FIG. 2 shows a sketch of the leakage diagnosis system 4 according to the embodiment of the present invention.

The leakage diagnosis system 4 comprises a first connection point 5 and a second connection point 6 as well as a diaphragm pump 7. The diaphragm pump 7 is designed to convey fluid from the first connection point 5 to the second connection point 6.

The first connection point 5 and the second connection point 6 are each set up to be connected to the tank 3 or to be open to the environment 1 (atmospheric air). Which connection point 5, 6 is connected to the tank 3 depends on whether the leakage diagnosis is carried out by negative pressure or overpressure in the tank 3. If the second connection point 6 is connected to the tank 3, the fluid delivery of the diaphragm pump 7 causes an overpressure in the tank 3. If, on the other hand, the first connection point 5 is connected to the tank 3, the fluid delivery of the diaphragm pump 7 causes a negative pressure in the tank 3.

The diaphragm pump 7 has an electric motor 12 or can be driven by an electric motor 12. In addition, a first pump valve 10 and a second pump valve 11 are provided. The first pump valve 10 and the second pump valve 11 are arranged in series with and between the first connection point 5 and the second connection point 6 and are formed as non-return valves. The pump valves 10, 11 thus ensure that the fluid flow of the diaphragm pump 7 takes place in a predetermined direction as follows.

During an intake process of the diaphragm pump 7, there is a fluidic connection between the diaphragm pump 7 and the first connection point 5, but not between the diaphragm pump 7 and the second connection point 6. In a compression process of the diaphragm pump 7, there is a fluidic connection between the diaphragm pump 7 and the second connection point 6, but not between the diaphragm pump 7 and the first connection point 5. As a result, fluid is conveyed from the first connection point 5 to the second connection point 6 by means of the diaphragm pump 7 via the pump valves 10, 11.

FIG. 3 shows a sketch for explaining further details of an exemplary structure of the diaphragm pump 7 of the leakage diagnosis system 4 according to the embodiment.

The electric motor 12 is connected to an eccentric 13. The eccentric 13 is in turn connected to a connecting rod 14. The eccentric 13 converts a rotational force of the electric motor 12 into a linear force, which is transmitted to a diaphragm 15 of the diaphragm pump 7 by means of the connecting rod 14. As a result, a rotation of the electric motor 12, or more precisely of a shaft of the electric motor 12 not shown, causes a stroke movement of the diaphragm 15 and thus a compression process or an intake process of the diaphragm pump 7. In principle, a stroke movement of the diaphragm 15 effected by the electromagnet 8d results in an overpressure (compression process) or a negative pressure (intake process).

The leakage diagnosis system 4 as shown in FIG. 2 also comprises a ventilation valve 8. The ventilation valve 8 is connected parallel to the diaphragm pump 7 between the first connection point 5 and the second connection point 6 and has two positions 8a, 8b.

In the first position 8a, the ventilation valve 8 is open so that the first connection point 5 and the second connection point 6 are fluidically connected. This allows fluids, in particular air, to flow in both directions between the first connection point 5 and the second connection point 6 through the ventilation valve 8. In the second position 8b, the ventilation valve 8 is closed so that a fluid flow from the second connection point 6 through the ventilation valve 8 to the first connection point 5 is prevented. The ventilation valve 8 can be switched here continuously in particular between the two positions, so that fluid flows can also be only partially prevented, i.e. throttled.

For this purpose, the ventilation valve 8 has an electromagnet 8d and a spring 8c. The spring 8c is designed and arranged in such a way that it acts against a force exerted by the electromagnet 8d. In other words, a sufficiently high force generated by the electromagnet 8d compresses the spring 8c, allowing the ventilation valve 8 to be switched between the two positions 8a, 8b. When the electromagnet 8d is not energized, the ventilation valve 8 is in the first position 8a. FIG. 2 shows an energized state of the electromagnet 8d and thus the ventilation valve 8 in the second position 8b.

The fact that the electromagnet 8d can only overcome the spring force of the spring 8c when energized and thus switch the ventilation valve 8 to the second position 8b ensures that, in the event of a malfunction of the ventilation valve 8, it remains in the first position 8a so that ventilation of the tank 3 can be ensured.

The leakage diagnosis system 4 also comprises an evaluation unit 9. The evaluation unit 9 is connected to an electric motor 12 of the diaphragm pump 7 and to the electromagnet 8d of the ventilation valve 8. The evaluation unit 9 is set up to control the diaphragm pump 7 by the electric motor 12 and the ventilation valve 8 by the electromagnet 8d.

The evaluation unit 9 is also connected to a first pressure sensor 16, which detects a pressure at the first connection point 5, and to a second pressure sensor 17, which detects a pressure at the second connection point 6.

As an alternative or in addition to one or both pressure sensors 16, 17, the evaluation unit 9 can determine the pressure from electrical signals, in particular from a current consumption of the diaphragm pump 7. The current consumption correlates with the power of the diaphragm pump 7, particularly for a given nominal voltage, from which the pressure generated by the diaphragm pump 7 can be determined.

The leakage diagnosis system 4 also comprises a safety valve 18. The safety valve 18 is a spring-loaded non-return valve, for example, is connected to the first connection point 5 and the second connection point 6 in parallel with the diaphragm pump 7 and the ventilation valve 8. As a result, a possible excessive overpressure or negative pressure in the tank 3 is equalized by opening the safety valve 18 with an ambient pressure (atmospheric pressure).

An opening pressure is defined as a pressure difference between the first connection point 5 and the second connection point 6, which causes the safety valve 18 to open. A closing pressure is defined as a pressure difference between the first connection point 5 and the second connection point 6, which causes the safety valve 18 to close. The opening pressure and the closing pressure are different.

An effective surface of a sealing element 18a of the safety valve 18 is designed in such a way that the closing pressure is lower than the opening pressure. This is achieved, for example, by a conical sealing element 18a. In this case, the fluid pressure acts on the sealing element 18a in order to lift it from the valve seat (not shown) when the opening pressure is reached. The opening pressure—and therefore the closing pressure—is set by the spring force of a return spring 18b. As soon as the sealing element 18a is lifted from the valve seat, the effective area increases so that a force acting on the return spring 18b of the safety valve 18 due to the fluid pressure increases. As a result, the closing pressure, i.e. the pressure difference at which the safety valve 18 closes again, is below the opening pressure.

The fact that the closing pressure of the safety valve 18 is below the opening pressure of the safety valve 18 prevents the safety valve 18 from constantly opening and closing if a source of error that led to the excessive overpressure/negative pressure has not been eliminated. The further the differential pressure used for leakage diagnosis between the first connection point 5 and the second connection point 6 is below a permissible pressure for the tank 3, the better the tank 3 and the leakage diagnosis system 4 are protected against overload.

When the safety valve 18 is opened, the first connection point 5 and the second connection point 6 are fluidically connected to each other.

The safety valve 18 can also be connected to the evaluation unit 9, wherein the evaluation unit 9 can receive and process times, or durations, of the opening and/or closing of the safety valve 18. For example, a previously known opening pressure of the safety valve 18 can be compared with a pressure in the tank 3 recorded or determined at the time the safety valve 18 is opened in order to determine a possible malfunction of the diaphragm pump 7 and/or a pressure sensor 16, 17.

In the following, an operation of the leakage diagnosis system 4 is explained with reference to FIG. 4. FIG. 4 shows a block diagram of a method for heating the leakage diagnosis system 4 (step S0), a method for a leakage diagnosis (steps S1-S3) and a method for a functional diagnosis (steps S5-S9) according to an embodiment of the present invention.

In the heating step S0, electrical signals are supplied to the diaphragm pump 7 and/or the ventilation valve 8 and are different from the electrical signals for regular operation. In particular, the electrical signals for heating are high-frequency signals, especially energizing currents, which have the following effects.

In the event that the diaphragm pump 7 is heated, the electrical signals, in particular the amplitudes of these, are designed in such a way that the diaphragm pump 7 does not perform a stroke by the electrical signals. In other words, the diaphragm 15 is not deflected, or only to a small extent, so that the diaphragm 15 does not generate any pressure (compression or intake).

If the ventilation valve 8 is heated, the electrical signals, in particular their amplitudes, are such that the ventilation valve 8 is not switched or not switched completely between the first position 8a and the second position 8b.

Instead, the aforementioned electrical signals generate heat in the electrical lines, in particular in coils, of the diaphragm pump 7 and/or in the ventilation valve 8, for example in the electromagnet 8d of the ventilation valve 8.

The step S0 can be carried out for a predetermined time until a predetermined temperature is reached. The leakage diagnosis system 4 can also have at least one temperature sensor (not shown), with which the heating of the diaphragm pump 7 and/or the ventilation valve 8, in particular the entire leakage diagnosis system 4, can be controlled.

Once a predetermined temperature has been set, the leakage diagnosis method according to steps S1-S3 can be performed.

In a first method step S1 for the leakage diagnosis, the ventilation valve 8 is switched to the second position 8b. This prevents the flow of fluid through the ventilation valve 8 from the second connection point 6 to the first connection point 5.

In a second method step S2, the diaphragm pump 7 is operated to generate an overpressure or negative pressure in a tank 3 connected to the first connection point 5 or the second connection point 6. As already explained, the diaphragm pump 7 conveys fluid from the first connection point 5 to the second connection point 6.

In a third method step S3, a pressure, in particular a pressure curve, is determined in the connected tank 3 in order to draw conclusions about the presence of a leakage in the tank 3. Here, as explained above, the pressure can be detected by the pressure sensors 16, 17 and/or by the electrical signals from the diaphragm pump 7.

Between steps S2 and S3, the diaphragm pump 7 can be switched off in particular, since the pump valves 10, 11 and the closed ventilation valve 8 prevent pressure equalization between the first connection point 5 and the second connection point 6. If a falling pressure (overpressure in the tank 3 caused by the diaphragm pump 7) is detected by the pressure sensors 16, 17 during this time, it is possible to draw conclusions about a leakage in the tank 3 by this detection. For this purpose, for example, a pressure curve over time can be recorded by the pressure sensors 16, 17 and evaluated by the evaluation unit 9.

Alternatively, the pressure can also be detected once. In this case, it is assumed that the diaphragm pump 7 (after a predetermined pumping time) has produced a predetermined pressure in the tank 3. Then, after a predetermined waiting time, the pressure in the tank 3 can be detected by at least one of the pressure sensors 16, 17. If the detected pressure deviates from the predetermined pressure produced by the diaphragm pump 7, a leakage in the tank 3 can be inferred. The deviation between the detected pressure and the expected pressure can be compared in particular with experimentally determined values in order to draw conclusions about the presence and size of the leakage. For example, it can be determined that a leakage is only present if the deviation is above a predetermined threshold value in a predetermined period of time, for example to take into account fault tolerances or leakages in the leakage diagnosis system 4.

When using the electrical signals of the diaphragm pump 7 to determine the pressure generated by the diaphragm pump 7, the diaphragm pump 7 can, for example, be operated constantly between steps S2, S3. If there is a leakage in the tank 3, the current consumption of the diaphragm pump 7 increases to generate the predetermined pressure. Here, in turn, an expected current consumption of the diaphragm pump 7 can be compared with an experimentally determinable setpoint value so that the presence of a leakage can be inferred. A determined fluid delivery rate of the diaphragm pump 7 can also be used to draw conclusions about the magnitude of the leakage.

After determining the presence of a possible leakage and its magnitude, a diagnosis method can be carried out with which, in accordance with steps S4-S9, a functional diagnosis of the leakage diagnosis system 4 is performed. This can be used in particular to rule out a false result of the leakage diagnosis method.

In a first diagnosis step S4, the ventilation valve 8 is switched to the second position 8b if it is in the first position 8a.

In a second diagnosis step S5, the diaphragm pump 7 is operated in pulsating mode in order to generate a pulsating overpressure or negative pressure in the tank 3. In this case, the diaphragm pump 7 is controlled in such a way that it performs a full or partial stroke several times in succession, i.e. in a pulsating manner.

In a third diagnosis step S6, the pressure generated by the diaphragm pump 7 is detected by the pressure sensors 16, 17. Also, only pressure sensor 16, 17 can be used here, which is connected to the tank 3 by the first connection point 5 or the second connection point 6.

In a fourth diagnosis step S7, the electrical signal used to operate the diaphragm pump 7 in step S5 and the detected pressure are used to check for the presence of a malfunction of the diaphragm pump 7. In other words, the target pressure controlled by the pulsating diaphragm pump 7 is compared with the actual pressure detected. In particular, a difference between the target pressure and the actual pressure can be determined. If this difference is above a predetermined threshold value, a malfunction of the diaphragm pump 7 can be inferred.

It is known here which actuated stroke of the diaphragm pump 7 leads to which pressure in a fault-free state, so that the set pressure can be determined or is known from the actuation signals for the diaphragm pump 7.

The detection of the pressure in the diagnosis step S6 is carried out with a time resolution in particular, so that the generated pulsation of the pressure can be compared with the actuated pulsating stroke of the diaphragm pump 7. In particular, only one fluid volume element is considered per pulse, which makes the function diagnosis particularly precise.

The function diagnosis can be canceled after diagnosis step S7 if only a functional diagnosis of the diaphragm pump 7 is to be performed.

Alternatively, a functional diagnosis of the ventilation valve 8 can also be carried out as follows.

In a further fifth diagnosis step S8, an electrical signal from the ventilation valve 8 generated by the switching of the ventilation valve 8 is detected. This can in particular be a counter-induction of the ventilation valve 8 or the electromagnet 8d of the ventilation valve 8.

In a sixth diagnosis step S9, the electrical signal generated by the ventilation valve 8, for example the aforementioned counter-induction, is then used to determine the presence of a malfunction of the ventilation valve 8.

Here, the generated electrical signal (actual signal), especially the counter-induction, can be compared with stored setpoint values, in particular a difference between them can be formed. If, for example, the ventilation valve 8 is jammed and cannot be switched (completely) between the first position 8a and the second position 8b, the counter-induction of the electromagnet 8d rises. A malfunction of the ventilation valve 8 can be determined by comparing the stored setpoint values.

The step S0, together the steps S1-S3, together the steps S4-S7 and together the steps S8, S9, form independent sub-methods, which can be carried out in any order and with any repetitions. For example, the step S0 can also be carried out after steps S1-S9, or between steps S1-S3 and S4-S9.

It should also be noted here that the heating step S0 can be carried out for the diaphragm pump 7 and/or the ventilation valve 8. This can also be carried out selectively together with the other steps S1-S9. For example, only a heating S0 of the diaphragm pump 7, the leakage diagnosis S1-S3 and the function diagnosis S4-S7 can be performed. Alternatively, only a heating S0 of the ventilation valve 8, the leakage diagnosis S1-S3 and the function diagnosis for the ventilation valve 8 can be carried out in accordance with diagnosis steps S8, S9.

The aforementioned steps S0-S9 are performed in particular by the evaluation unit 9. For this purpose, the evaluation unit 9 can have or be a CPU/GPU/FPGA. Alternatively or additionally, an engine control unit (not shown) of the vehicle 2 can be designed as the aforementioned evaluation unit 9.

In addition to the above written description, explicit reference is hereby made to the drawings of the invention in FIGS. 1 to 4 for a supplementary disclosure thereof.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

### LIST OF REFERENCE SIGNS

1 environment
2 vehicle
3 tank
4 leakage diagnosis system
5 first connection point
6 second connection point
7 diaphragm pump
8 ventilation valve
8a first position
8b second position
8c spring
8d electromagnet
9 evaluation unit
10 first pump valve
11 second pump valve
12 electric motor
13 eccentric
14 connecting rod
15 membrane
16 first pressure sensor
17 second pressure sensor
18 safety valve
18a sealing element
18b return spring 18b
S0 heating step
S1 first step
S2 second step
S3 third step
S4 first diagnosis step
S5 second diagnosis step
S6 third diagnosis step
S7 fourth diagnosis step
S8 fifth diagnosis step
S9 sixth diagnosis step

1-10. (canceled)

11. A leakage diagnosis system for a tank of a vehicle, comprising:
at least one first connection point and a second connection point, each configured to be connected to the tank or to be open to an environment;
at least one diaphragm pump, configured to convey fluid from the first connection point to the second connection point;
at least one ventilation valve, connected parallel to the diaphragm pump between the first connection point and the second connection point and configured to be switched into a first position, in which the first connection point and the second connection point are fluidically connected, and into a second position, which prevents a fluid flow at least from the second connection point to the first connection point; and
at least one evaluation unit configured to operate the diaphragm pump, to switch the ventilation valve to the second position and to determine a pressure, including a pressure profile, in a tank connected to the first connection point or second connection point in order to draw conclusions about the presence of a leakage in the tank from the pressure, including the pressure profile;
wherein the at least one evaluation unit is set up to detect electrical signals, including a current consumption, of the diaphragm pump and to determine therefrom a target pressure, to detect as actual pressure a pressure generated by the diaphragm pump, by at least one pressure sensor, and to determine the presence of a malfunction of the diaphragm pump by the electrical signals and the detected pressure, wherein the at least one evaluation unit identifies the malfunction if a difference between target pressure and actual pressure exceeds a predefined limit value.

12. The leakage diagnosis system as claimed in claim 11, further comprising a first pump valve between the first connection point and the diaphragm pump and a second pump valve between the second connection point and the diaphragm pump arranged in series with the diaphragm pump, and the first pump valve and the second pump valve are configured such that during an intake process of the diaphragm pump a fluidic connection exists between the diaphragm pump and the first connection point, but not the second connection point, and in a compression process of the diaphragm pump a fluidic connection exists between the diaphragm pump and the second connection point, but not the first connection point.

13. The leakage diagnosis system as claimed in claim 11, further comprising at least one pressure sensor which is fluidically connected to the first connection point or the second connection point in order to measure a pressure in a tank connected to the first connection point or the second connection point.

14. The leakage diagnosis system as claimed in claim 13, wherein the at least one first pressure sensor fluidically connected to the first connection point and a second pressure sensor fluidically connected to the second connection point in order to measure a pressure in the tank and a pressure in the environment.

15. The leakage diagnosis system as claimed in claim 11, further comprising at least one safety valve, which is connected to the first connection point and/or the second connection point in order to reduce a pressure difference between the tank connected to the first connection point or the second connection point and the environment in an at least a partially open position.

16. A vehicle comprising a tank and the leakage diagnosis system as claimed in claim 11, wherein the tank is fluidically connected to the first connection point or the second connection point of the leakage diagnosis system.

17. A method for a functional diagnosis of a leakage diagnosis system, comprising at least one first connection point and a second connection point, which are each configured to be connected to the tank or open to an environment, at least one diaphragm pump which is configured to convey fluid from the first connection side to the second connection side, and at least one ventilation valve which is connected in parallel with the diaphragm pump between the first connection point and the second connection point and is configured to be switched in a first position, in which the first connection point and the second connection point are fluidically connected, and a second position, which prevents a fluid flow at least from the second connection point to the first connection point, wherein the method comprises:
a first diagnosis step, in which the ventilation valve is switched into the second position;
a second diagnosis step, in which the diaphragm pump is operated, in a pulsating manner, in order to generate an overpressure or a negative pressure in a tank connected to the first connection point or second connection point;
a third diagnosis step, in which the pressure generated by the diaphragm pump is detected, by at least one pressure sensor, as actual pressure; and
a fourth diagnosis step, in which electrical signals, including a current consumption, of the diaphragm pump are detected and therefrom a target pressure is determined, wherein the presence of a malfunction of the diaphragm pump is determined by the target pressure and by the detected actual pressure, wherein the malfunction is identified if a difference between the target pressure and actual pressure exceeds a predefined limit value.

18. The method as claimed in claim 17, further comprising a fifth diagnosis step, in which an electrical signal of the ventilation valve generated by the switching of the ventilation valve is detected, and a sixth diagnosis step, in which the presence of a malfunction of the ventilation valve is determined by the generated electrical signal of the ventilation valve.
